(19) United States
(12) Patent Application Publication
(10) Pub. No.: US 2018/0260927 A1
(43) Pub. Date: Sep. 13, 2018

(54) METHODS AND SYSTEMS FOR ENHANCING TRANSPORTATION HUB SECURITY

(71) Applicant: Scott Hoenigman, Alexandria, VA (US)

(72) Inventor: Scott Hoenigman, Alexandria, VA (US)

(21) Appl. No.: 15/455,950

(22) Filed: Mar. 10, 2017

(51) Int. Cl. G06Q 50/26; G06Q 30/00; G08G 1/01; G08G 1/13

(52) U.S. Cl. CPC G06Q 50/26; G08G 1/13; G08G 1/01; G06Q 30/018

(57) ABSTRACT

A method for enhancing transportation hub security is provided that includes determining a vehicle entered a transportation hub when the vehicle crosses a geo-fence that at least partially surrounds the transportation hub, and determining that the vehicle violated a transportation hub rule or regulation. Moreover, the method includes issuing in real-time, by a computer system, a fine for a citation prepared for the violation. The citation includes details of the violation and the computer system stores citation data for driver violations. Furthermore, the method includes updating the citation data to include the citation details, and analyzing, by the computer system, the updated citation data for areas having concentrations of violations that meet or exceed a threshold concentration.

### BACKGROUND OF THE INVENTION

This invention relates generally to transportation hub security, and more particularly, to methods and systems for enhancing transportation hub security.

Travelers typically use subways, taxis, buses and other forms of transportation to get to and from transportation hubs such as airports and train stations. Recently, Transportation Network Companies (TNC) have developed which use online enabled platforms to connect travelers with drivers using their own vehicles. Some transportation hubs have been known to uses electronic geo-fences to track TNC vehicle activity.

Transportation hubs have also been known to create special staging areas for TNC vehicles and to implement other rules and regulations to control TNC traffic. However, the staging areas, rules and regulations have been known to reduce driver earnings which has caused some TNC drivers to avoid the staging areas and find ways around the rules. The rules and regulations are typically designed to emphasize safety and traffic control which result in better security. Consequently, drivers who violate the rules and regulations compromise security.

Transportation hub security personnel include investigators who enforce the rules and regulations. During traffic stops, investigators typically take notes, take pictures of TNC vehicles with their own smart devices, and rely on their own memory to record the details of a rules violation which are used to prepare a report after the violation occurs. Investigators typically don't prepare their reports until a few weeks after the violation, and each investigator typically prepares his or her reports at different times. Each report is emailed to a business office which assesses fines against the TNC or the TNC driver depending on the details of the violation included in the report. Investigating officers have been known to e-mail the reports monthly, and business offices have been known to process the reports and issue fines monthly. As part of processing the reports the business office updates the data for each driver.

The reports are also analyzed to identify areas with high concentrations of violations. High concentrations of violations in certain areas have been known to identify areas that have traffic and/or security concerns. After analyzing the reports, transportation hubs have been known to change the security schemes in areas with large numbers of violations, and, if necessary, to change traffic movement. However, because it may take a month or more to collect enough data to identify problem areas, problem areas may exist for long periods of time and thus jeopardize safety. Because transportation hubs incur costs to ensure traveler and pedestrian safety, TNC drivers who do not follow the rules and regulations may cause transportation hub security costs to increase.

### BRIEF DESCRIPTION OF THE INVENTION

In one aspect, a method for enhancing transportation hub security is provided that includes determining a vehicle entered a transportation hub when the vehicle crosses a geo-fence that at least partially surrounds the transportation hub, and determining that the vehicle violated a transportation hub rule or regulation. Moreover, the method includes issuing in real-time, by a computer system, a fine for a citation prepared for the violation. The citation includes details of the violation and the computer system stores citation data for driver violations. Furthermore, the method includes updating the citation data to include the citation details, and analyzing, by the computer system, the updated citation data for areas having concentrations of violations that meet or exceed a threshold concentration.

In another aspect, a computer system for enhancing transportation hub security is provided that includes a processor and a memory. The memory is configured to store at least citation data and the computer system is associated with a network. The memory is in communication with the processor and has instructions stored thereon which, when executed by the processor, cause the computer system to determine a vehicle entered a transportation hub when the vehicle crosses a geo-fence that at least partially surrounds the transportation hub. Moreover, the instructions when read and executed by the computer system cause the computer system to determine that the vehicle violated a transportation hub rule or regulation, and issue a fine for a citation prepared for the violation. The citation includes details of the violation. Furthermore, the instructions when read and executed by the computer system cause the computer system to update the citation data to include the citation details, and analyze the updated citation data for areas having concentrations of violations that meet or exceed a threshold concentration.

In yet another aspect, a computer program recorded on a non-transitory computer-readable recording medium included in a computer system for enhancing transportation hub security is provided. The computer program includes instructions, which when read and executed by the computer system, cause the computer system to determine a vehicle entered a transportation hub when the vehicle crosses a geo-fence that at least partially surrounds the transportation hub, and determine that the vehicle violated a transportation hub rule or regulation. Moreover, the instructions when read and executed by the computer system cause the computer system to issue a fine for a citation prepared for the violation. The citation includes details of the violation. Furthermore, the instructions when read and executed by the computer system cause the computer system to update the citation data to include the citation details and analyze the updated citation data for areas having concentrations of violations that meet or exceed a threshold concentration.

### BRIEF DESCRIPTION OF THE DRAWINGS

FIG. 1 is a diagram of an example computing system used for enhancing security of transportation hubs;

FIG. 2 is a diagram illustrating an example computing system architecture;

FIG. 3 is a diagram illustrating an electronic map of an example transportation hub site;

FIG. 4 is an example table including data records for TNC vehicles;

FIG. 5 is a flowchart illustrating an example method for enhancing transportation hub security;

FIG. 6 is a diagram illustrating an example citation; and

FIG. 7 is a flowchart illustrating another example method for enhancing transportation hub security.

### DETAILED DESCRIPTION OF THE INVENTION

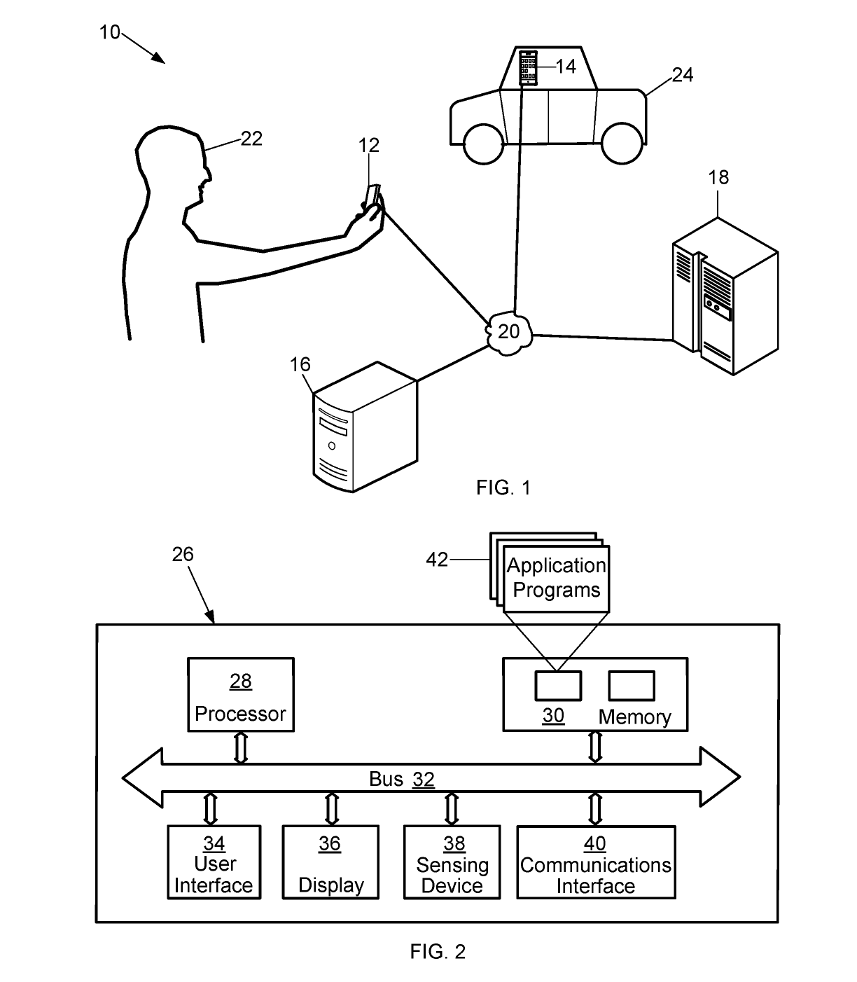

FIG. 1 is a diagram illustrating an example Security Enhancing Computer (SEC) System 10 used to enhance transportation hub security. More specifically, the SEC system 10 includes an investigator computing device 12, a driver computing device 14, a Transportation Network Company Computer (TNCC) system 16, and a Web Server Computer (WSC) system 18 that communicate over a network 20.

The investigator and driver computing devices 12, 14 may be any device capable of at least capturing data and performing the functions described herein. One example of the computing devices 12, 14 is a smart phone. Other examples of the computing devices 12, 14 include, but are not limited to, a cellular phone, a tablet computer, a phablet computer, a laptop computer, and any type of device having wired or wireless networking capabilities such as a personal digital assistant (PDA). The computing devices 12, 14 may obtain data and store the obtained data therein. Alternatively, or additionally, the computing devices 12, 14 may transmit the obtained data to the TNCC system 16, the WSC system 18, or other computing devices (not shown) or computing systems (not shown).

The investigator computing device 12 is associated with a particular transportation hub investigator 22. Investigators 22 are transportation hub security personnel who monitor TNC vehicle traffic and enforce the rules and regulations. Investigators 22 may include police officers. Transportation hub sites usually have many investigators 22, each of whom is associated with a different computing device substantially the same as the investigator computing device 12. Consequently, the example SEC system 10 is not limited to including a single computing device 12. Rather, the example SEC system 10 may include any number of investigator computing devices 12.

The driver computing device 14 belongs to a particular TNC driver and is thus associated with that particular TNC driver. Each particular TNC driver is also associated with a different vehicle 24. Thus, the computing device 14 of each particular TNC driver may also be associated with the vehicle 24 associated with that particular driver. There are usually many computing devices 14 and associated TNC vehicles 24 at a transportation hub at any time. Thus, the example SEC system 10 is not limited to including a single vehicle 24 and associated driver computing device 14. Rather, the example SEC system 10 may include any number of vehicles 24 and associated driver computing devices 14. Due to the association between the computing device 14 and the vehicle 24 of each driver, the location of the device 14 may be considered the location of the associated TNC vehicle 24.

The TNCC system 16 includes components such as, but not limited to, a web server, a database server, an application server, a directory server and a disk storage unit that may be used to store any kind of data. The disk storage unit may store at least one database such as, but not limited to, a TNCC driver information database.

The TNCC system 16 communicates with at least the computing devices 12, 14 and the WSC system 18 over the network 20. Additionally, the TNCC system 16 performs functions including, but not limited to, storing data for each TNCC driver, storing data for geo-fences, and monitoring the location of TNC vehicles. Data stored for each driver includes, but is not limited to, driver name, type of car, TNCC unique identification number, and license plate data. Moreover, the TNCC system 16 may store data regarding the computing device 14 of each driver, for example, the device phone number.

The TNCC system 16 typically receives location data from the computing device 14 about every five seconds. However, the location data may be received at any temporal interval. The location data is calculated by the computing device 14 and may be calculated from the network 20 or based on Global Positioning System (GPS) coordinates.

The WSC system 18 includes components such as, but not limited to, a web server, a database server, an application server, a directory server and a disk storage unit that may be used to store any kind of data. The disk storage unit may store at least one database such as, but not limited to, a database of citations for violations of transportation hub rules.

The WSC system 18 communicates with at least the computing device 12 and the TNCC system 16 over the network 20. Additionally, the WSC system 18 performs functions including, but not limited to, hosting a website regarding many aspects of TNC driver activity at one or more transportation hubs, storing citation data for TNC driver violations, storing records of every transaction that occurs within a geo-fence, displaying electronic maps of transportation hub sites on the web site, issuing citations and/or fines in real-time or near real-time, displaying TNC vehicles 24 on the electronic maps, transmitting messages to investigators operating the computing devices 12, and monitoring TNC vehicle transactions.

The communications network 20 is a 5G communications network. Alternatively, the communications network 20 may be any wireless network including, but not limited to, 4G, 3G, Wi-Fi, Global System for Mobile (GSM), Enhanced Data for GSM Evolution (EDGE), and any combination of a LAN, a wide area network (WAN) and the Internet. The network 22 may also be any type of wired network or a combination of wired and wireless networks. The SEC system 10 may also include other computing devices (not shown) and computing systems (not shown) able to communicate over the network 20. The other computing devices (not shown) may be similar to computing devices 12, 14, and are each typically associated with a different individual. The other computing systems (not shown) include, but are not limited to, ride sharing service computer systems, transportation hub computer systems, hotel computer systems, and service provider computer systems able to communicate over the network 20.

FIG. 2 is a diagram illustrating an example computing system architecture 26 that may be included in the computing devices 12, 14, and the components comprising the TNCC and the WSC systems. The architecture includes, for example, one or more processors 28, a memory 30, a bus 32, a user interface 34, a display 36, a sensing device 38 and a communications interface 40. Alternatively, any number of memories, user interfaces, displays, sensing devices, and communications interfaces may be included. Moreover, some example architectures may omit, for example, the sensing devices or the display.

The processor 28 executes instructions, or computer programs, stored in the memory 30. As used herein, the term processor is not limited to just those integrated circuits referred to in the art as a processor, but broadly refers to a computer, a microcontroller, a microcomputer, a programmable logic controller, an application specific integrated circuit, and any other programmable circuit capable of executing the functions described herein. The above examples are not intended to limit in any way the definition and/or meaning of the term “processor.” General communication between the components is provided via the bus 32.

As used herein, the term “computer program” is intended to encompass an executable program that exists permanently or temporarily on any computer-readable recordable medium that causes the investigators computing devices 12, the driver computing devices 14, the TNCC system 16, and the WSC system 18 to perform at least the functions described herein. Application programs 42, also known as applications, are computer programs stored in the memory 30. Application programs 42 include, but are not limited to, an operating system, an Internet browser application, a citation issuing application, or any special computer program that manages the relationship between application software and any suitable variety of hardware that helps to make-up a computer system or computing environment.

The memory 30 may be a computer-readable recording medium used to store data including, but not limited to, computer programs, photographs, videos, and TNC driver violations. The memory 30 may also be used to store any data regarding an individual, or individuals, associated with a driver computing device 14. The memory 30 may be implemented using any appropriate combination of alterable, volatile or non-volatile memory or non-alterable, or fixed, memory. The alterable memory, whether volatile or non-volatile, can be implemented using any one or more of static or dynamic RAM (Random Access Memory), a floppy disc and disc drive, a writeable or re-writeable optical disc and disc drive, a hard drive, flash memory or the like. Similarly, the non-alterable or fixed memory can be implemented using any one or more of ROM (Read-Only Memory), PROM (Programmable Read-Only Memory), EPROM (Erasable Programmable Read-Only Memory), EEPROM (Electrically Erasable Programmable Read-Only Memory), an optical ROM disc, such as a CD-ROM or DVD-ROM disc, and disc drive or the like. Furthermore, the memory 30 may include smart cards, SIMs or any other medium from which a computing device can read computer programs, applications or executable instructions.

The user interface 34 and the display 36 allow interaction between a user and a computing device or between a user and a computing system. The display 36 may include a visual display or monitor that displays information to a user. For example, the display 36 may be a Liquid Crystal Display (LCD), active matrix display, plasma display, or cathode ray tube (CRT). The user interface 34 may include a keypad, a keyboard, a mouse, an infrared light source, a microphone, cameras, and/or speakers. Moreover, the user interface 34 and the display 36 may be integrated into a touch screen display. Accordingly, the display may also be used to show a graphical user interface, which can display various data and provide “forms” that include fields that allow for the entry of information by the user. Touching the screen at locations corresponding to the display of a graphical user interface allows the person to interact with the respective device or system to enter data, change settings, control functions, etc. Consequently, when the touch screen is touched, the user interface 34 communicates this change to the processor 28, and settings can be changed or user entered information can be captured and stored in the memory 30.

The sensing device 38 may include Radio Frequency Identification (RFID) components or systems for receiving information from other devices. The sensing device 38 may alternatively include components with Bluetooth, Near Field Communication (NFC), infrared, or other similar capabilities.

The communications interface 40 provides a computing device or a computing system with two-way data communications. Moreover, the communications interface 40 enables conducting wireless communications such as cellular telephone calls and wirelessly accessing the Internet over the network 20. By way of example, the communications interface 40 may be a digital subscriber line (DSL) card or modem, an integrated services digital network (ISDN) card, a cable modem, or a telephone modem to provide a data communication connection to a corresponding type of telephone line. As another example, the communications interface 40 may be a local area network (LAN) card (e.g., for Ethernet™ or an Asynchronous Transfer Model (ATM) network) to provide a data communication connection to a compatible LAN. As yet another example, the communications interface 40 may be a wire or a cable connecting the respective device or system with a LAN, or with accessories such as printers and scanners. Further, the communications interface 40 may include peripheral interface devices, such as a Universal Serial Bus (USB) interface, a PCMCIA (Personal Computer Memory Card International Association) interface, and the like. Thus, it should be understood that the communications interface 40 may enable conducting any type of wireless or wired communications such as, but not limited to, accessing the Internet over the network 20.

The communications interface 40 also allows the exchange of information across networks such as the communications network 20. The exchange of information may involve the transmission of radio frequency (RF) signals through an antenna (not shown). Moreover, the exchange of information may be between the computing devices 12, 14, the systems 16, 18, and any other computing systems (not shown) and computing devices (not shown) capable of communicating over the network 20.

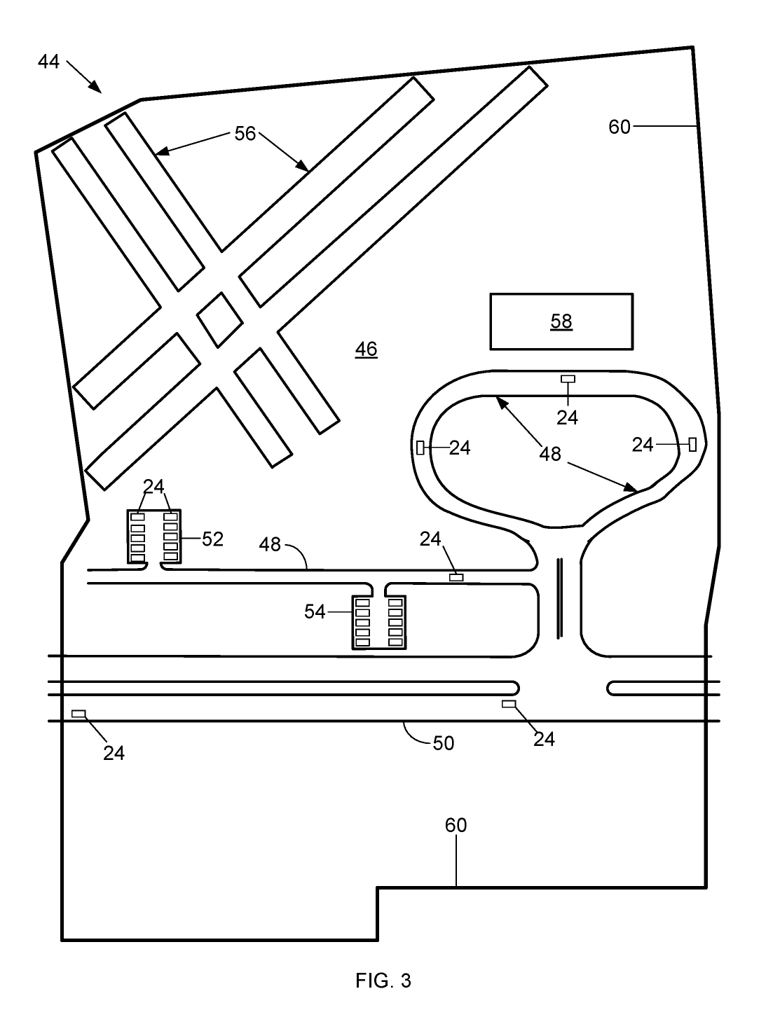

FIG. 3 is an electronic map 44 illustrating an example transportation hub site 46. The site 46 includes internal roads 48, an access road 50, a TNC vehicle staging area 52, a cell-phone parking lot 54, runways 56, and a structure 58. The example transportation hub site 46 is an airport. However, the transportation hub site 46 may alternatively be any type of transportation hub site, for example, a train station or a bus depot. The internal roads 48 enable drivers to access specific areas of the site 46, for example, the structure 58, the staging area 52, and the cell-phone parking lot 54. The access road 50 serves as a travel artery connecting the site 46 with surrounding communities. The structure 58 is an airport terminal building. However, the structure 58 may be any type of building depending on the type of transportation hub. Although a single structure 58 is included in the site 46, any number of structures 58 may be included on the site 46. The number of structures 58 depends on the type of the transportation hub and the volume of travelers served by the hub.

The vehicle staging area 52 is a parking lot for TNC vehicles 24 waiting to be contacted about picking-up a traveler at the structure 58. Requiring TNC drivers to wait in the staging area 52 facilitates reducing vehicular traffic on the internal roads 48 which results in less vehicular and pedestrian traffic congestion at the entrance to the structure 58. Terrorists have been known to target areas crowded with people. For example, terrorists have been known to explode vehicles in crowded areas. Consequently, reducing the size of any crowds that may develop at the structure entrance should reduce the attractiveness of the entrance as a terrorist target and thus facilitate enhancing security against terrorist attacks. Moreover, less vehicular and pedestrian traffic facilitates reducing vehicular and pedestrian accidents which enhances transportation hub security. Less vehicular and pedestrian traffic also reduces the wear and tear on the roads 48 and other hub facilities which facilitates extending their useful lives and reduces maintenance costs. Thus, requiring TNC drivers to wait in the staging area 52 facilitates enhancing transportation hub security and reducing maintenance costs.

The cell-phone parking lot 54 is for drivers, not associated with a TNC, who are temporarily on the site 46 to pick-up travelers, for example, a son picking-up his parents returning from a trip. When the staging area 52 is full, TNC drivers have been known to park in the cell-phone lot 54. At least some TNC drivers believe that being closer to the structure 58 increases the chances of being contacted about picking-up a traveler. The more travelers a TNC driver serves, the more money the driver makes. Consequently, some TNC drivers have been known to park in the lot 54 hoping to receive more frequent contacts and thus increase income. However, transportation hub operating rules typically prohibit TNC drivers from parking in the cell-phone lot 54.

Transportation hubs typically create a series of rules governing operation of TNC vehicles on transportation hub sites 46. For example, the rules may require TNC drivers to park in the staging area 52 while waiting to be contacted about picking-up a traveler, display identifying information while on the site 46, and display license plates that match plate information stored in the WSC system 18. Actions taken by transportation hubs for rules violations vary. For example, investigators may be required to intercept a vehicle and confirm information about the TNC vehicle and driver if the vehicle was previously cited for improperly displaying license plates. If a driver has received an additional citation, for example, for loitering in the cell-phone lot 54, another rule may require forbidding the driver from conducting TNC business at the transportation hub site 46. Transportation hubs may implement any number of rules regarding operation of TNC vehicles on sites 46 that facilitate reducing traffic and enhancing traveler and pedestrian safety.

An example geo-fence 60 may be displayed on the map 44. The geo-fence 60 may be created and modified by the operator of the transportation hub using a computer system (not shown), which may transmit the electronic geo-fence to the WSC system 18. The geo-fence 60 is created in one of three formats: KML, GeoJSON or an ESRI Shapefile. However, the geo-fence 60 may be created in any format that facilitates enhancing transportation hub security as described herein. The WSC system 18 displays the geo-fence 60 on the electronic map 44. The geo-fence 60 may also be transmitted to other computing systems and/or devices able to communicate over the network 20 including the TNCC system 16.

The geo-fence 60 may have any configuration and may completely or partially surround the site 46. For example, the geo-fence 60 may have a configuration that matches the property lines of the site 46, partially matches the property lines, or does not match any of the property lines. For configurations that partially match the property lines, the balance of the geo-fence 60 may have any shape. Likewise, configurations that do not match any property lines may have any shape. The shapes may be any that may be created from lines and curves. Example shapes include, but are not limited to, circles, ovals, squares, and rectangles. Although a single geo-fence 60 is described herein, multiple geo-fences may alternatively be positioned on the same site 46. Multiple geo-fences 60 may overlap, or not.

The geo-fence 60 facilitates identifying TNC vehicles entering and exiting the site 46. More specifically, the TNCC system 16 compares the location data received from a TNC driver computing device 14 against the location of the geo-fence 60. When the comparison indicates the TNC driver computing device 14 crossed the geo-fence 60 and is within the geo-fence 60, the TNCC system 16 concludes that the vehicle 24 associated with the driver computing device 14 is also within the geo-fence 60. The TNCC system 16 creates a unique trip identification number (TIN) for each driver computing device 14 that crosses the geo-fence 60 and transmits the TIN with additional data to the WSC system 18. The additional data may include, but is not limited to, model and year of the vehicle 24, vehicle license plate data, and the date and time the vehicle 24 crossed the geo-fence 60. The TNCC system 16 may periodically transmit location data for the vehicle to the WSC system 18 while the vehicle 24 is on the site 46, and ceases transmitting the location data when the vehicle 24 crosses the geo-fence 60 while leaving the site 46. The period may be any duration of time that enables accurate real-time or near real-time monitoring of the vehicle 24 on the site 46, for example, five seconds.

The location of each TNC vehicle 24 on the site 46 at any time may be displayed by the electronic map 44. The locations may be updated as additional location data is received from the TNCC system 16. TNC vehicles 24 may be displayed on the electronic map 44 while traveling on the access road 50, on the internal roads 48, and while dropping-off and picking-up travelers. Moreover, the TNC vehicles 24 may be displayed on the map 44 in any color in accordance with any scheme. An example scheme may require that vehicles operating for different companies be displayed in different colors. For example, vehicles operating for company TNC-1 may be displayed in orange, vehicles operating for company TMC-2 may be displayed in green, and vehicles operating for company TMC-3 may be displayed in yellow. However, vehicles associated with enhanced data may not be displayed in accordance with the color scheme.

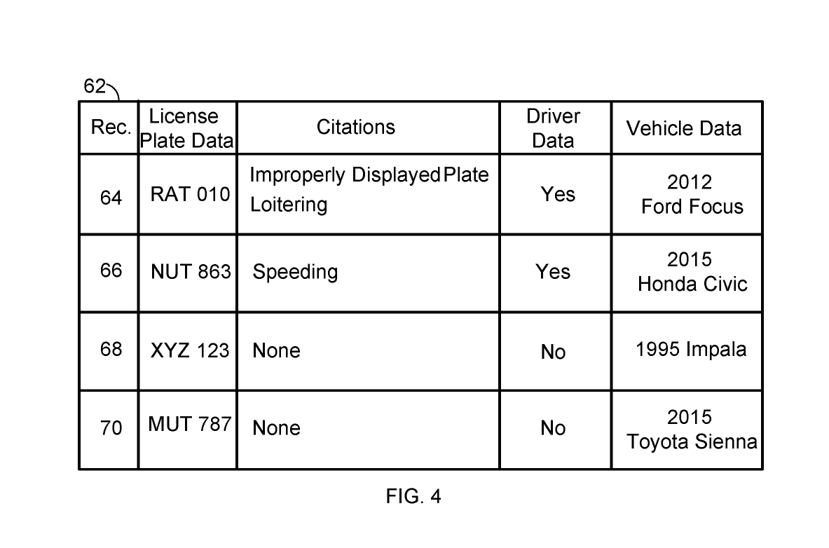

FIG. 4 is a diagram illustrating an example table 62 including data records for example TNC vehicles 24. The table 62 may be stored in the WSC system 18. The table 62 includes four example data records 64, 66, 68, and 70. Each data record includes the TNC vehicle license plate data and enhanced data. The enhanced data is data other than the license plate data and includes, but is not limited to, citations issued against the license plate, driver data, and vehicle data. The enhanced data includes any data that may facilitate enhancing the security of transportation hubs as described herein. The license plate data is alphanumeric data, but may be numeric or alphabetic.

The WSC system 18 compares the license plate data received from the TNCC system 16 against the corresponding license plate data in the table 62 to determine if the license plate is associated with enhanced data. If the license plate data is associated with enhanced data, the enhanced data is compared against the rules and regulations to determine which color should be used to display the vehicle. The rules and regulations may forbid vehicles with two or more citations, or that are seven years or older, from operating on the site 46 and displays such vehicles in red. The rules and regulations may also require that any vehicle having enhanced data is to be displayed in blue, unless the enhanced data requires displaying in another color. In view of the above, the vehicles associated with license plate data RAT 010 and XYZ 123 should be displayed in red, while the vehicles associated with license plate data NUT 863 and MUT 787 should be displayed in blue.

The electronic map 44 may be included in a website operated by the WSC system 18 and may be accessed by any device able to communicate via the Internet. Consequently, each investigator may use his or her computing device 12 to access the website and display the map 44. Investigators may view the displayed vehicles and click on the vehicles with enhanced data which causes the computing device to also display the enhanced data for the investigator to see.

Some colors may require that investigators act with respect to a TNC vehicle 24. For example, TNC vehicles 24 displayed in red are forbidden from operating as a TNC vehicle on the site 46, so investigators 22 are required to intercept and escort such vehicles 24 off the site 46. TNC vehicles 24 displayed in purple may require extra scrutiny. Consequently, investigators 22 may be required to stop such vehicles to confirm the accuracy of the data transmitted from the TNCC system 16 to the WSC system 18 when the vehicle entered the geo-fence 60. For example, the investigators may confirm that an imposter is not driving the TNC vehicle 24 and that the TNC driver associated with the TNC vehicle 24 is driving.

The TNC vehicles 24 may also be displayed on the map 44 with symbols. For example, upon entering the geo-fence 60 vehicles may be displayed with an open door to symbolize entry into the geo-fence 60. After dropping-off a traveler, the vehicle may be displayed with an up arrow, while a down arrow is displayed after picking-up a traveler. After a vehicle exits the geo-fence 60 it is not displayed on the map 44.

Although the table 62 includes four records 64, 66, 68, and 70, the table 62 may alternatively include any number of records. Additionally, the table 62 may include any additional information that would enable enhancing transportation hub security.

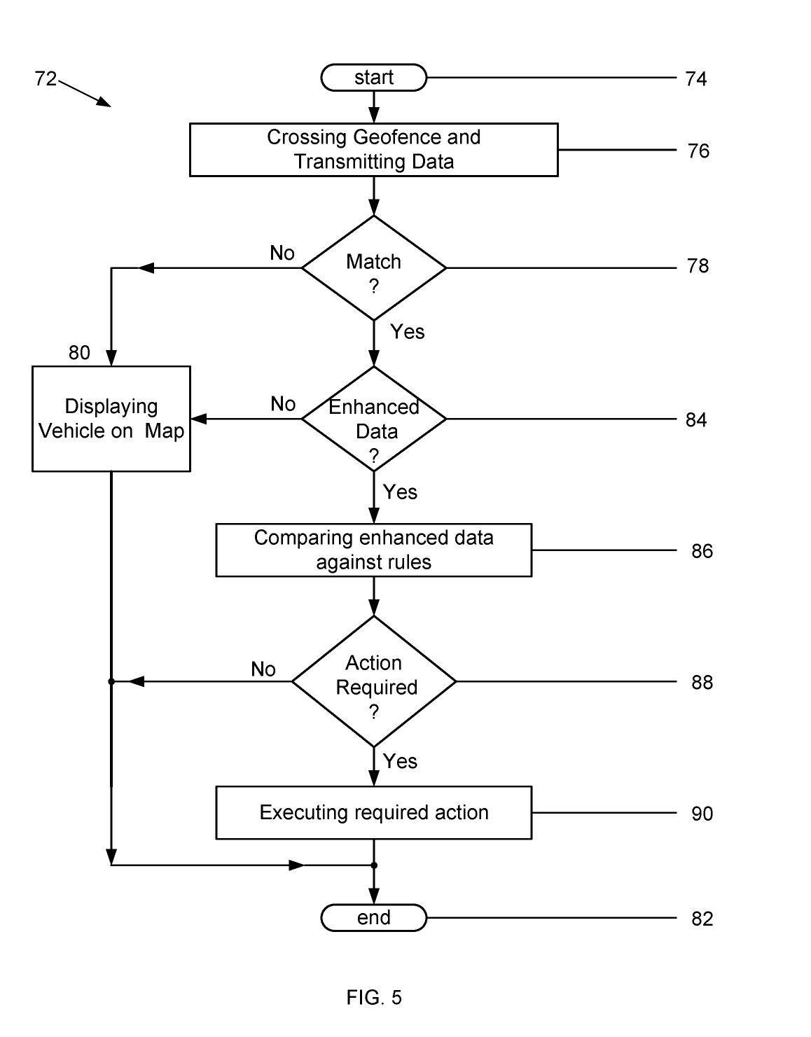

FIG. 5 is a flowchart 72 illustrating an example method for enhancing transportation hub security. The method starts 74 with a driver computing device 14 transmitting location data to the TNCC system 16, which compares the received location data against the geo-fence 60 location. The vehicle operates for TNC-2. When TNCC system 16 calculations indicate that the TNC vehicle 24 crossed 76 the geo-fence 60 and entered the site 46, the TNCC system 16 continues by transmitting 76 data about the TNC vehicle 24 to the WSC system 18. The transmitted data includes at least the license plate data of the vehicle.

The WSC system 18 continues by determining 78 whether or not the received license plate data matches 78 any license plate data stored therein. Specifically, the WCS system 18 compares the received license plate data against the license plate data stored therein. When matching 78 license plate data is not detected, processing continues by displaying 80 the vehicle on the electronic map 44 in the color assigned to TNC-2 and processing ends 82. However, when matching 78 license plate data is detected, processing continues by determining 84 whether the transmitted data includes enhanced data. When the transmitted data does not include enhanced data 84, processing continues by displaying 80 the vehicle on the electronic map 44 in the color assigned to TNC-2. However, when the transmitted data includes enhanced data processing continues by comparing 86 the enhanced data against the rules and regulations to determine which color should be used to display the vehicle on the electronic map 44.

After determining the color and displaying the vehicle on the electronic map 44, security personnel are able to monitor the map 44 to determine whether an action 88 is required regarding the vehicle. If an action 88 is not required, processing ends 82. However, when an action 88 is required, security personnel continue by executing the required action 90. The required actions vary with the rules and regulations and include, but are not limited to, issuing a citation, confirming accuracy of data transmitted from the TNCC system 16, and escorting the vehicle off site. All data regarding the executed action is documented and stored in the WSC system 18. Next, processing ends 82.

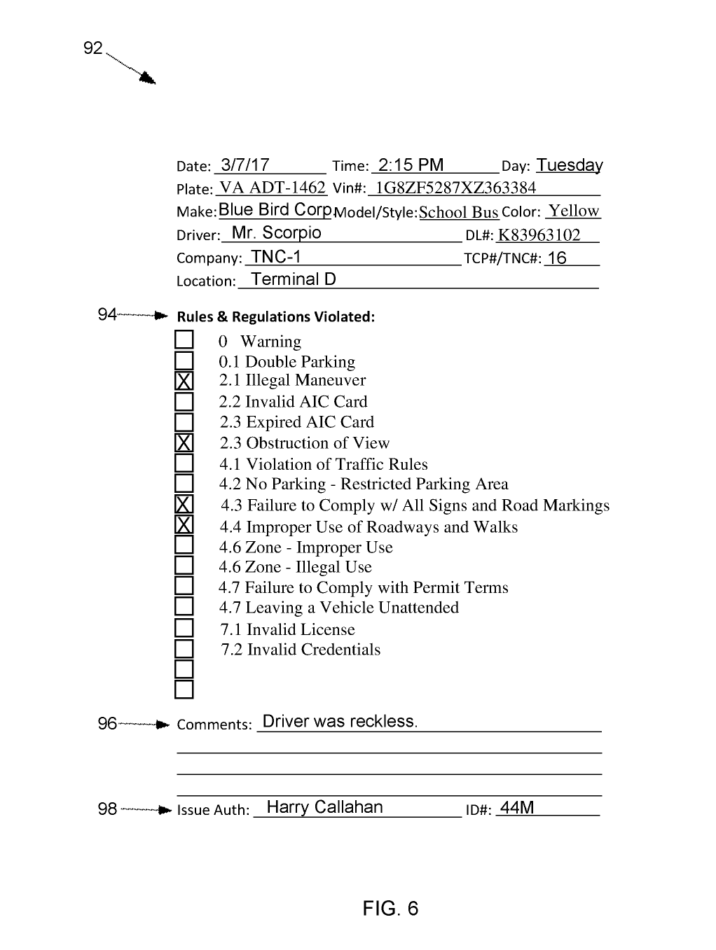

FIG. 6 is a diagram illustrating an example citation 92 issued by security personnel on the transportation hub site 46. The citation 92 includes the date, time and day that a citation was issued as well as information about the vehicle 24 stopped by an investigator. The vehicle information includes, but is not limited to, the license plate data, vehicle identification number, the make and model, and color. The citation 92 also includes the driver's name and license number, the TNC and a TNC number, as well as the location at which the citation was issued. The citation may alternatively, or additionally, include any other information that may be used for identifying the TNC vehicle and/or TNC driver.

The example citation 92 also includes fifteen example rules and regulations 94 that TNC drivers are not to violate. Alternatively, the example citation 92 may include any number of rules and regulations. Moreover, the rules and regulations 94 may be the same or different than the example rules and regulations. For the example citation 92, the driver was cited for violating rule and regulation numbers 2.1, 2.3, 4.3, and 4.4 which correspond to making an illegal maneuver, obstruction of view, failure to comply with all signs and road markings, and improper use of road ways and walks.

The citation 92 also includes a section 96 for investigator comments as well as investigator identifying information 98. For the example citation 92, the investigator indicated the driver was reckless. The citation 92 was issued by investigator Harry Callahan whose identification number is 44M.

The citation 92 may be displayed by the computing device 12 and completed by an investigator during TNC vehicle stops. More specifically, an investigator may obtain information about the TNC driver and vehicle, and enter the information in the citation 92. The investigator also indicate which rules and regulations 94 were violated. After entering the data, the investigator may cause the computing device 12 to generate a report and transmit the report to the WSC system 18 which may issue a fine in real-time or near real-time. Alternatively, the computing device 12 may automatically generate and transmit the report. Moreover, the WSC system 18 updates the data record of the TNC driver to reflect the violation and fine. The update is immediately available and thus assists investigators in future stops of the same TNC vehicle. For example, when an investigator issues a warning citation to a TNC driver for making an illegal maneuver in the morning and the same or different investigator stops the same TNC driver in the afternoon for making the same or different illegal maneuver, a citation for a fine will likely be given because the investigator knows the driver already received a warning. Thus, processing citations in real-time or near real-time allows implementing a progressive set of penalties.

Real-time or near real-time processing of citations by the WSC system 18 also facilitates quickly identifying areas with high concentrations of violations and thus identifying problem areas in which traffic patterns and/or security schemes to change, which facilitates increasing safety.

Security personnel do not catch all violations committed by TNC vehicles. The WSC system 18 stores records regarding every TNC transaction that occurs within the geo-fence 60. These records may be used to identify anomalies that may facilitate catching violations not caught by security personnel. For example, a transportation hub may have a rule permitting drop-offs and/or pick-ups only at designated locations. The WSC system 18 records may show that a TNC vehicle made a drop-off and/or a pick-up outside the designated locations. Upon discovering a TNC vehicle made a drop-off or a pick-up outside the designated locations the WSC system 18 may automatically issue a citation and fine. Moreover, identifying drop-offs and/or pick-ups outside the designated locations facilitates quickly identifying possible security issues that can be quickly addressed by security personnel before being exploited by terrorists.

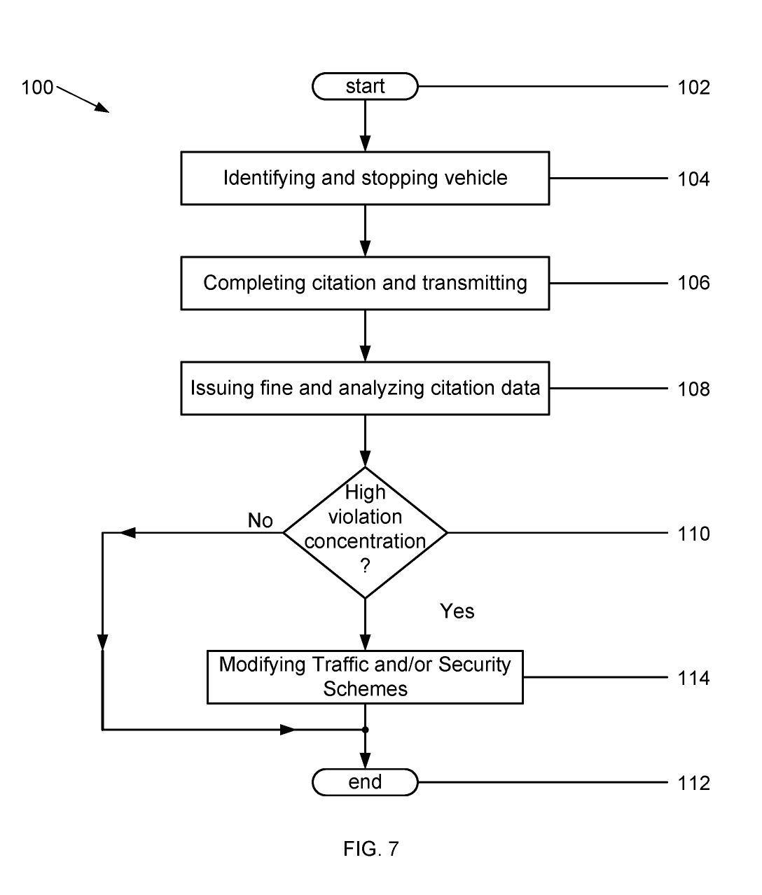

FIG. 7 is a flowchart 100 illustrating another example method for enhancing transportation hub security. The method starts 102 with a transportation hub investigator determining that a TNC vehicle committed a rule violation, and identifying 104 and stopping 104 the TNC vehicle. The investigator may witness the violation or may identify the vehicle by monitoring the electronic map 44 on his or her computing device 12. After stopping 104 the vehicle, the investigator approaches the vehicle and causes the computing device 12 to display the citation 92, interrogates the TNC driver and completes 106 the citation 92 by entering the required information. Next, the investigator causes the computing device 12 to transmit 106 the completed citation 92 to the WSC system 18 which issues 108 a fine in real-time or near real-time and updates all the data stored therein to reflect the citation and the data included in the citation. The computing device 12 may alternatively transmit the citation automatically.

The WSC system 18 continues by analyzing 108 all the citation data to detect anomalies and to determine areas that have high concentrations of violations. A high concentration of violations may be an hourly citation rate that meets or exceeds a threshold. The threshold may be five citations per hour. However, the threshold may be any rate deemed to evidence a traffic or security concern.

When no areas have a high violation concentration 110, processing ends 112. However, if an area has a high concentration of violations 110 processing continues by transmitting a message to the computing devices 12 of all the investigators identifying the area indicating that the traffic and/or security schemes in that area require modification. Security personnel determine which modifications are required and modify 114 the traffic and/or security schemes accordingly. Next, processing ends 112.

The methods described herein may be conducted entirely or partly on the computing device 12, the computing device 14, the TNCC system 16, the WSC system 18, and any other computing devices (not shown) and computing systems (not shown) able to communicate over the network 20. Moreover, data described herein as being stored in the computing device 12 and the computing device 14 may alternatively be stored in the TNCC system 16, the WSC system 18, or any computing system (not shown) or computing device (not shown) able to communicate over the network 20. Likewise, at least some of the data described herein as being stored in the TNCC system 16 and the WSC system 18 may alternatively be stored in the computing device 12, the computing device 14, or in any computing system (not shown) or computing device (not shown) able to communicate over the network 20.

The above-described example methods and systems for enhancing transportation hub security facilitate detecting areas experiencing high concentrations of citations and modifying traffic and/or security schemes in the detected areas of the transportation hub. More specifically, an investigator identifies a TNC vehicle committing a rules violation and completes a citation for the violation using his or her computing device. The citation is transmitted to a computer system which issues a fine in real-time and updates citation data stored therein with the information from the transmitted citation. The computer system analyzes the updated citation data for areas of the transportation hub experiencing high concentrations of violations. Traffic and security schemes in the areas experiencing high concentrations of violations are modified to enhance safety. Moreover, data collected by the computer system regarding each TNC vehicle trip is stored therein and may be analyzed to identify TNC vehicle behavioral trends on the transportation hub site that can be used to enhance security. As a result, the security of transportation hubs against terrorist attacks is facilitated to be increased, and the time and costs associated with providing the enhanced security is facilitated to be reduced.

The example methods for enhancing transportation hub security described above should not be considered to imply a fixed order for performing the method steps. Rather, the method steps may be performed in any order that is practicable, including simultaneous performance of at least some steps. Furthermore, the invention is not limited to the embodiments of the methods described above in detail. Rather, other variations of the methods may be utilized within the spirit and scope of the claims.

What is claimed is:

1. A method for enhancing transportation hub security comprising:
determining a vehicle entered a transportation hub when the vehicle crosses a geo-fence that at least partially surrounds the transportation hub;
determining that the vehicle violated a transportation hub rule or regulation;
issuing in real-time, by a computer system, a fine for a citation prepared for the violation, the citation including details of the violation, the computer system stores citation data for driver violations;
updating the citation data to include the citation details; and
analyzing, by the computer system, the updated citation data for areas having concentrations of violations that meet or exceed a threshold concentration.

2. A method for enhancing transportation hub security in accordance with claim 1 further comprising transmitting a message to investigator computing devices identifying an area having a concentration of violations that exceeds the threshold concentration.

3. A method for enhancing transportation hub security in accordance with claim 1 said determining step comprising monitoring an electronic map and identifying a color of the vehicle displayed on the map.

4. A method for enhancing transportation hub security in accordance with claim 1 further comprising:
displaying the vehicle in a color on an electronic map; and
determining whether an action is required regarding the vehicle based on the color.

5. A method for enhancing transportation hub security in accordance with claim 1 further comprising modifying a security scheme for areas having concentrations of violations that meet or exceed the threshold concentration.

6. A computer system for enhancing transportation hub security comprising:
a processor; and
a memory configured to store at least citation data, said computer system being associated with a network and said memory being in communication with said processor and having instructions stored thereon which, when executed by said processor, cause said computer system to:
determine a vehicle entered a transportation hub when the vehicle crosses a geo-fence that at least partially surrounds the transportation hub;
determine that the vehicle violated a transportation hub rule or regulation;
issue a fine for a citation prepared for the violation, the citation including details of the violation;
update the citation data to include the citation details; and
analyze the updated citation data for areas having concentrations of violations that meet or exceed a threshold concentration.

7. A computer system for enhancing transportation hub security in accordance with claim 6, wherein the instructions when read and executed by said processor further cause said computer system to transmit a message to investigator computing devices identifying an area having a concentration of violations that exceeds a threshold concentration.

8. A computer system for enhancing transportation hub security in accordance with claim 6, wherein the instructions when read and executed by said processor further cause said computer system to display the vehicle in a color on an electronic map, the color corresponding to an action required regarding the vehicle.

9. A computer system for enhancing transportation hub security in accordance with claim 6, wherein the instructions when read and executed by said processor further cause said computer system to;
compare data regarding the vehicle against the transportation hub rules and regulations; and
display the vehicle on an electronic map in a color based on the comparison.

10. A computer program recorded on a non-transitory computer-readable recording medium included in a computer system for enhancing transportation hub security, the computer program being comprised of instructions, which when read and executed by the computer system, cause the computer system to:
determine a vehicle entered a transportation hub when the vehicle crosses a geo-fence that at least partially surrounds the transportation hub;
determine that the vehicle violated a transportation hub rule or regulation;
issue a fine for a citation prepared for the violation, the citation including details of the violation;
update the citation data to include the citation details; and
analyze the updated citation data for areas having concentrations of violations that meet or exceed a threshold concentration.

11. A computer program in accordance with claim 10 further comprising instructions, which when read and executed by the computer system cause the computer system to transmit a message to investigator computing devices identifying an area having a concentration of violations that exceeds a threshold concentration.

12. A computer program in accordance with claim 10 further comprising instructions, which when read and executed by the computer system cause the computer system to:
compare data regarding the vehicle against the transportation hub rules and regulations; and
display the vehicle on an electronic map in a color based on the comparison.
